(19) United States
(12) Patent Application Publication
(10) Pub. No.: US 2011/0185350 A1
(43) Pub. Date: Jul. 28, 2011

(54) SHARED-PROGRAM UPDATING SYSTEM

(76) Inventor: Mitsuru Kawahata, Iwaki (JP)

(21) Appl. No.: 13/005,211

(22) Filed: Jan. 12, 2011

(30) Foreign Application Priority Data
Jan. 26, 2010 (JP) JP 2010-014034

(51) Int. Cl. G06F 9/44

(52) U.S. Cl. 717/171; 717/168

(57) ABSTRACT

A shared-program updating system for updating a shared program that is loaded in a memory and is dynamically linked to and shared by other programs, includes an update processing unit that updates a target shared program, which is shared by the other programs, and which is to be updated. The update processing unit includes 1) an updating access control section that directs each of a plurality of using programs, serving as the other programs that access the target shared program, to stop accessing the target shared program and, after the target shared program is updated, allows the using program to resume accessing the target shared program, and 2) an updating section that updates the target shared program after the using program has stopped accessing the target shared program.

### PRIORITY CLAIM

This application claims the benefit of Japanese Patent Application No. 2010-014034, filed on Jan. 26, 2010, and which is incorporated by reference herein in its entirety.

### BACKGROUND

1. Field of the Invention

The present invention relates to a technique for updating a program, such as a dynamic link library (DLL), shared by a plurality of programs.

2. Description of the Related Art

As one of techniques for updating a program, such as a DLL, shared by a plurality of programs, a technique of hooking a request to load the DLL which is yet to be updated from a program using the DLL, loading the updated DLL, and allowing the program to use the updated DLL so that the DLL is updated without interrupting a running system or the execution of a program has been known (refer to, for example, Japanese Unexamined Patent Application Publication No. 2002-24037).

According to the technique disclosed in Japanese Unexamined Patent Application Publication No. 2002-24037, when a program using a loaded DLL to be updated exists upon updating the DLL, the DLL used by the program cannot be changed to the updated DLL. In this case, both of the program using the DLL to be updated and a program using the updated DLL exist in a system. Disadvantageously, an unexpected trouble may be caused by the inconsistency between the programs.

### SUMMARY

Accordingly, it is an object of the present invention to provide a technique for updating a shared program while preventing a running system or the execution of a program from being interrupted so that all of programs using the shared program use the updated shared program.

According to an aspect of the present invention, there is provided a shared-program updating system for updating a shared program which is loaded in a memory and is dynamically linked to and shared by other programs, the system including an update processing unit that updates a target shared program, serving as the shared program which is to be updated and is loaded in the memory. The update processing unit includes an updating access control section that allows each of using programs, serving as the other programs using the target shared program, to stop accessing the target shared program and, after the target shared program is updated, allows the using program to resume accessing the target shared program, and an updating section that updates the target shared program after the updating access control section allows the using program to stop accessing the target shared program.

According to this system, the loaded shared program is updated after only the access to the shared program, serving as a target to be updated, from each using program using the shared program is stopped. Accordingly, the target shared program can be updated without interrupting the entire system or another program which does not use the target shared program. Since each of the using programs uses the updated shared program, the use of a plurality of versions of the shared program is prevented.

The system may further includes a use control unit that issues a right to access the shared program to each of the other programs using the shared program in response to a request to issue the right to access the shared program from the other program, and receives the right to access the shared program returned from the other program. The updating access control section allows the use control unit to stop issuing the right to access the target shared program and, after the target shared program is updated by the updating section, allows the use control unit to resume issuing the right to access the target shared program. After the updating access control section allows the use control unit to stop issuing the access right and all of the rights to access the target shared program are then returned from the using programs to the use control unit, the updating section updates the target shared program. The other program using the shared program requests the use control unit to issue the right to access the shared program, accesses the shared program when the use control unit issues the access right in response to the issue request, and returns the access right to the use control unit at the completion of the access.

The system may further include a use control unit that issues a right to access the shared program to each of the other programs using the shared program in response to a request to issue the right to access the shared program from the other program, and receives the right to access the shared program returned from the other program. The updating access control section allows the use control unit to stop issuing the right to access the target shared program and notify each using program of stopping the use of the target shared program, and after the target shared program is updated by the updating section, allows the use control unit to resume issuing the right to access the target shared program and notify the using program of resuming the use of the target shared program. After the updating access control section allows the use control unit to stop issuing the access right and all of the rights to access the target shared program are then returned from the using programs to the use control unit, the updating section updates the target shared program. The other program using the shared program requests the use control unit to issue the right to access the shared program, accesses the shared program when the use control unit issues the access right in response to the issue request, and returns the access right to the use control unit at the completion of the access. Each of the using programs stops the use of the target shared program and does not request to issue the right to access the target shared program during the interval between the time when the using program is notified of stopping the use of the target shared program and the time when the using program is notified of resuming the use.

This configuration can prevent each using program from uselessly issuing a request to issue the right to access the target shared program.

The above-described system may further include an update control unit that searches for a newer version of the shared program when access of at least one of the using programs to the shared program is failed due to a program on the shared program side, acquires the latest version of the shared program when the newer version is found, sets the shared program of the found newer version as the target shared program, and allows the update processing unit to update the target shared program to the acquired latest version.

In this system, the update control unit may access a distribution server storing the shared program to search for the newer version of the shared program and acquire the searched-for latest version of the shared program from the distribution server. Alternatively, the update control unit may access a removable medium storing the shared program to search for the newer version of the shared program and acquire the searched-for latest version of the shared program from the removable medium.

In the above-described system, the shared program may be a dynamic link library (DLL).

The system may be an in-vehicle system mounted on a car.

### BRIEF DESCRIPTION OF THE DRAWINGS

FIG. 1 is a block diagram of an in-vehicle system according to an embodiment of the present invention;

FIG. 2 is a functional block diagram of the in-vehicle system according to the embodiment;

FIG. 3 is a block diagram illustrating a DLL use management table according to the embodiment;

FIG. 4 is a flowchart of a DLL updating process according to the embodiment; and

FIG. 5 is a flowchart of a DLL use limiting process according to the embodiment.

### DETAILED DESCRIPTION

An embodiment of the present invention will be described with respect to an application to an in-vehicle system.

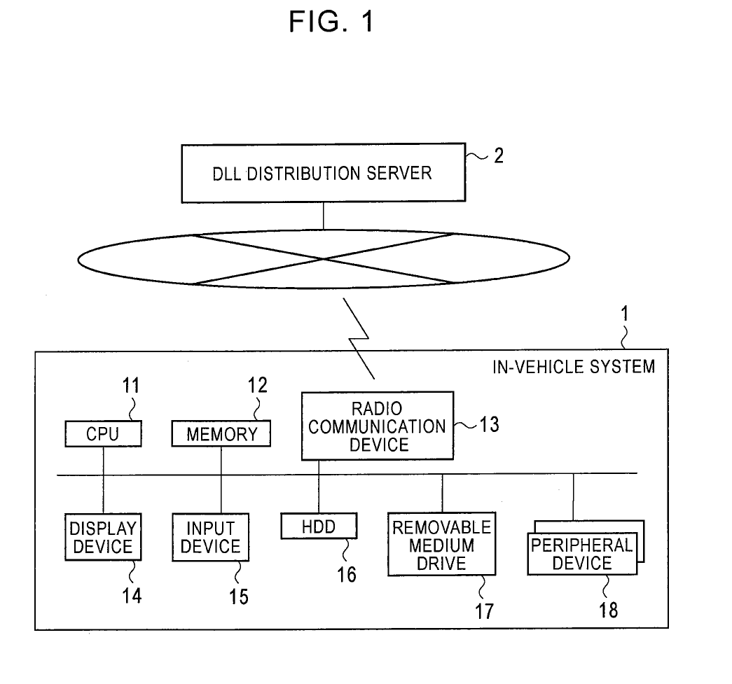

FIG. 1 illustrates the configuration of the in-vehicle system.

The in-vehicle system, indicated at 1, is a system mounted on a car. Referring to FIG. 1, the in-vehicle system 1 includes a CPU 11, a memory 12, a radio communication device 13, a display device 14, an input device 15, a hard disk drive (HDD) 16, a removable medium drive 17 which serves as a DVD/CD drive, and various peripheral devices 18, and functions as a computer. The CPU 11 loads a program stored in the HDD 16 into the memory 12 and executes the program, thus realizing a software configuration including an operating system and an application running on the operating system. The application of the in-vehicle system 1 uses the radio communication device 13 through the operating system to access a DLL distribution server 2 which distributes DLL files.

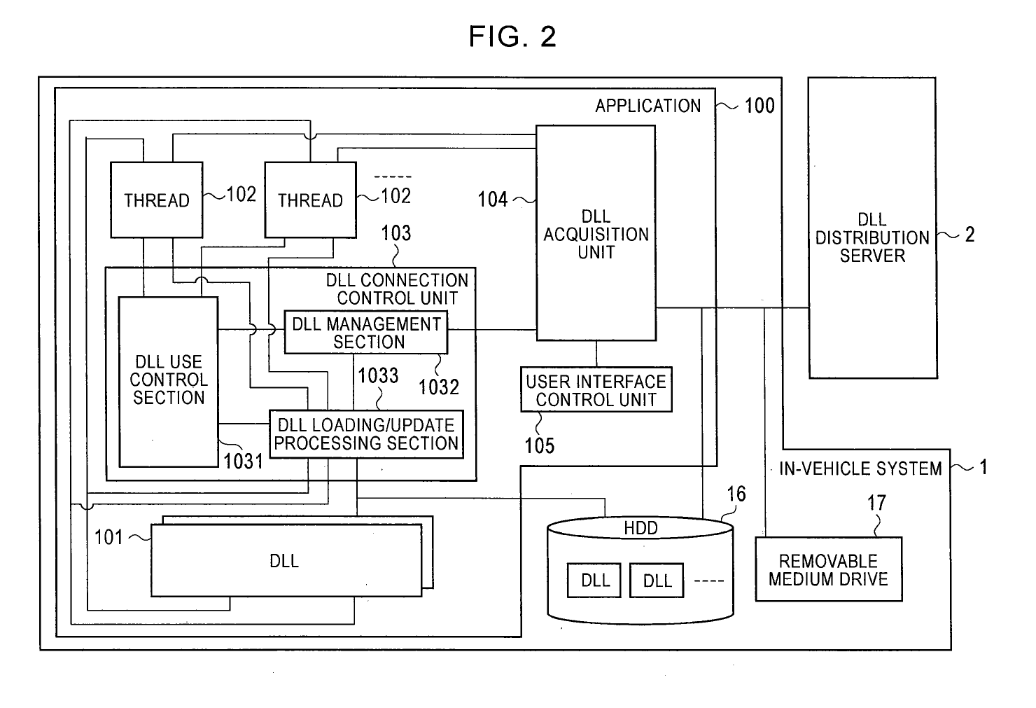

FIG. 2 illustrates the configuration of the application related to DLLs in the in-vehicle system 1.

Referring to FIG. 2, the application, indicated at 100, includes DLLs 101 loaded in the memory 12, threads 102 each of which serves as an execution unit of the application program loaded in the memory 12 and also serves as a user of the DLLs 101, a DLL connection control unit 103 which controls the use of the DLLs 101 by the threads 102 or the update of each loaded DLL 101, a DLL acquisition unit 104, and a user interface control unit 105.

The above-described DLLs 101, threads 102, DLL connection control unit 103, DLL acquisition unit 104, and user interface control unit 105 run on the operating system (not illustrated) while using functions of the operating system.

The DLL connection control unit 103 includes a DLL use control section 1031, a DLL management section 1032, and a DLL loading and update processing section (hereinafter, “DLL loading/update processing section”) 1033.

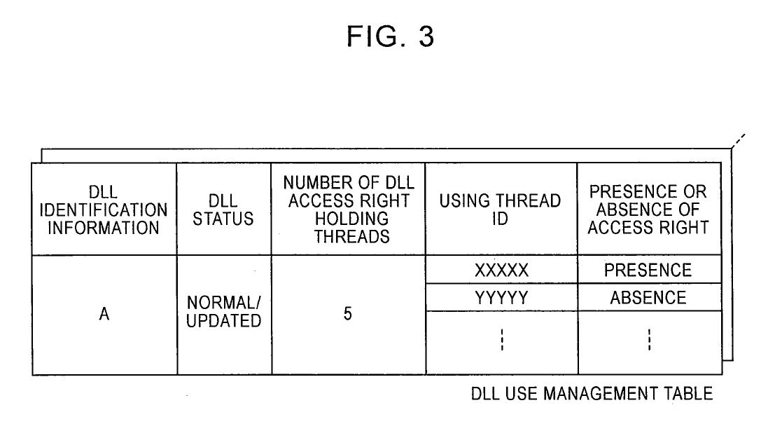

FIG. 3 illustrates a DLL use management table which the DLL use control section 1031 has in order to manage the use of each DLL 101.

The DLL use management table is provided for each loaded DLL. As illustrated in FIG. 3, DLL identification information indicating the identification of the corresponding DLL 101, a DLL status indicating a status of the corresponding DLL 101, i.e., whether the DLL 101 is in a normal status (“NORMAL”) or being updated (“UPDATED”), the number of DLL access right holding threads, namely, the number of threads each holding a right to access the corresponding DLL 101, using thread identifier (ID) indicating the ID of each using thread which serves as the thread 102 using the corresponding DLL 101, and the presence or absence of the access right of each using thread, namely, whether the using thread holds the right to access the corresponding DLL 101 are registered in each DLL use management table.

An operation of using a certain DLL 101 and an operation of updating the DLL 101 in the in-vehicle system 1 will be described below.

First, a normal operation of using the DLL 101 will be described.

A certain thread 102 which intends to start the use of the DLL 101 requests the DLL loading/update processing section 1033 of the DLL connection control unit 103 to load the target DLL. In response to this request, the DLL loading/update processing section 1033 loads the target DLL 101 from the HDD 16 into the memory 12, incorporates the DLL 101 into the application 100, and notifies the thread 102, serving as a request source, of successful loading. If the DLL 101 has already been loaded, the loading is not actually performed and the thread 102, serving as the request source, is notified of the successful loading.

If the DLL 101 is loaded, the DLL loading/update processing section 1033 notifies the DLL management section 1032 of the identification of the loaded DLL 101 (e.g., the DLL name), the version thereof, and a list of functions (functions and methods) of the DLL 101. The DLL management section 1032 stores the identification of the DLL 101, the version thereof, and the list of functions thereof. In addition, the DLL loading/update processing section 1033 notifies the DLL use control section 1031 of the identification of the loaded DLL 101. In response to this notification, the DLL use control section 1031 generates a DLL use management table associated with the relevant. DLL 101. The DLL use control section 1031 enters the identification as DLL identification information, enters “NORMAL” as a DLL status, and enters the number of DLL access right holding threads as “0”.

The thread 102, which serves as the load-request source and which have been notified of the successful loading, requests the DLL use control section 1031 to register the thread as a thread using the relevant DLL 101. In response to this request, the DLL use control section 1031 enters the ID of the thread 102, serving as a registration-request source, as a using thread ID into the DLL use management table associated with the relevant DLL 101 and enters “ABSENCE” as information indicating the presence or absence of the access right relevant to the using thread ID.

After that, each thread 102, whose ID has been entered as the using thread ID in the DLL use management table, performs the following operation each time the thread 102 intends to use a function of the DLL 101.

The thread 102 requests the DLL use control section 1031 to give a right to access the DLL 101 to the thread. When the DLL use control section 1031 issues the access right to the thread 102, the thread accesses the DLL 101 to use a function of the DLL. At the completion of use of the function of the DLL 101, the thread 102 returns the access right to the DLL use control section 1031.

On the other hand, when receiving the request to give the right to access the DLL 101 from the thread 102, the DLL use control section 1031 issues the access right to the thread 102, serving as a request source, and increases the number of DLL access right holding threads by one so long as the ID of the thread 102 has been entered as a using thread ID in the DLL use management table associated with the relevant DLL 101 and “NORMAL” has been entered as the DLL status in the DLL use management table. If the ID of the thread 102 is not entered as a using thread ID in the DLL use management table associated with the relevant DLL 101, alternatively, if “UPDATED” has been entered as the DLL status in the DLL use management table, the DLL use control section 1031 rejects issuing the access right.

The DLL use control section 1031 further performs a process of, when all of the threads 102 indicated by the using thread IDs registered in the DLL use management table are finished, unloading the DLL 101 associated with the DLL use management table to delete the DLL use management table.

A normal updating operation for a certain DLL 101 will be described.

Assuming that a certain thread 102 acquires an access right as described above and then accesses a function of the DLL 101, if an access error is caused by a problem on the DLL 101 side, for example, a fact that the accessed function is not included in the DLL 101 or a malfunction in the DLL 101, the thread 102 notifies the DLL acquisition unit 104 of the ID of the DLL 101 which has caused the access error.

In response to this notification, the DLL acquisition unit 104 acquires the version of the relevant DLL 101 and the list of functions thereof from the DLL management section 1032 and also accesses the DLL distribution server 2 to acquire information indicating the latest version of the relevant DLL 101 and the list of functions thereof.

The DLL acquisition unit 104 allows the display device 14 through the user interface control unit 105 to display the comparison between the information, including the current version of the DLL 101 and the list of functions thereof, acquired from the DLL management section 1032 and the information, including the latest version of the DLL 101 and the list of functions thereof, acquired from the DLL distribution server 2, and then accepts an instruction to acquire the latest-version DLL 101 or an instruction indicating the non-necessity of acquisition from an operator.

When receiving the instruction to acquire the latest-version DLL 101 from the user, the DLL acquisition unit 104 accesses the DLL distribution server 2 to download the latest version of the DLL 101 into the HDD 16. At the completion of downloading, the DLL acquisition unit 104 instructs the DLL management section 1032 to perform a process of updating the DLL 101.

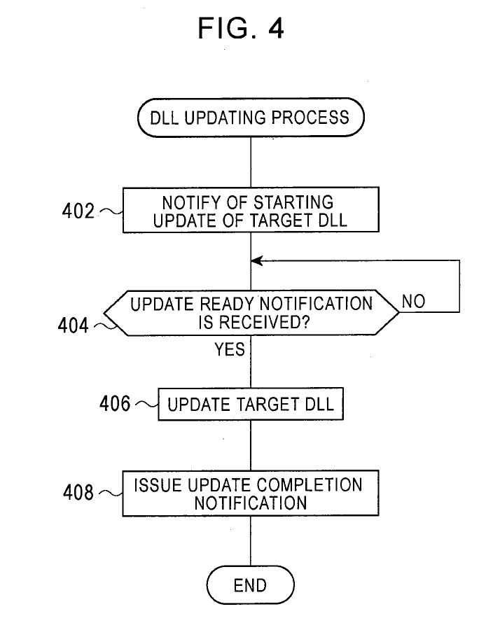

In response to this instruction, the DLL management section 1032 performs a DLL updating process illustrated in FIG. 4.

Specifically, the DLL management section 1032 sets the DLL 101 which is older than the latest-version DLL 101 downloaded in the HDD 16 among currently loaded DLLs 101 as a target DLL to be updated and notifies the DLL use control section 1031 of the start of updating the target DLL (step 402).

When receiving an update ready notification that the update of the target DLL is ready from the DLL use control section 1031 (step 404), the DLL management section 1032 allows the DLL loading/update processing section 1033 to update the target DLL to the latest-version DLL 101 downloaded in the HDD 16 (step 406).

When the update of the target DLL by the DLL loading/update processing section 1033 is completed, the DLL management section 1032 issues an update completion notification that the update of the target DLL is completed to the DLL use control section 1031 (step 408).

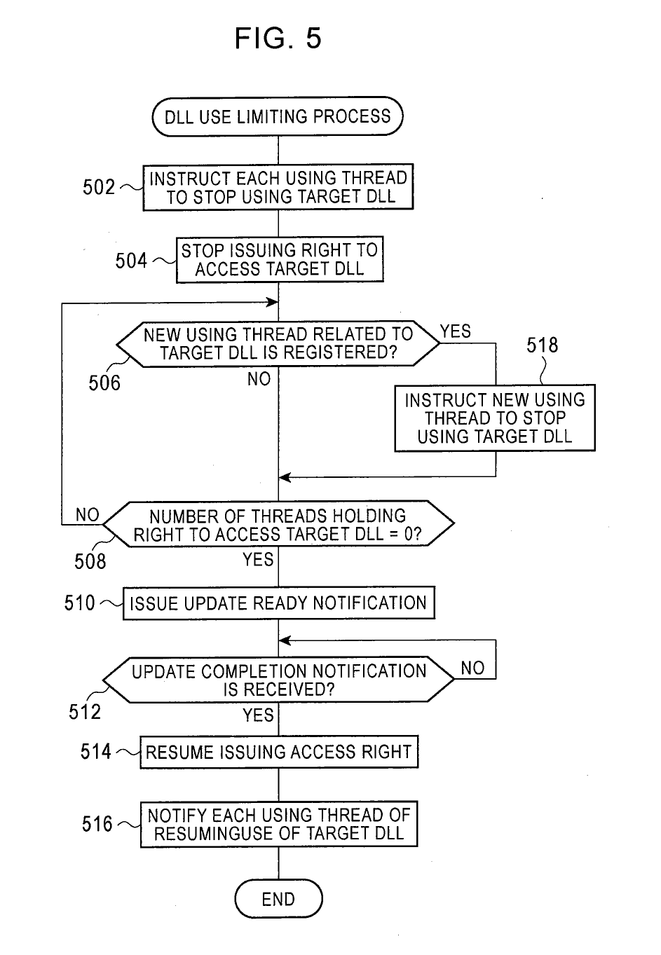

On the other hand, the DLL use control section 1031 performs a DLL use limiting process illustrated in FIG. 5 when being notified of the start of updating the target DLL by the DLL management section 1032.

Referring to FIG. 5, in this DLL use limiting process, the DLL use control section 1031 instructs each thread 102 whose ID has been entered as the using thread ID in the DLL use management table associated with the target DLL to stop using the target DLL (step 502). In response to this instruction, so long as the thread 102 holds a right to access the target DLL at this time, the thread 102 stops the use of a function of the target DLL, returns the right to access the target DLL, and stops subsequent issue of an access right request relevant to the target DLL. Even if the thread 102 does not hold the right to access the target DLL at this time, the thread 102 stops the subsequent issue of the access right request relevant to the target DLL.

The DLL use control section 1031 enters “UPDATED” as a DLL status in the DLL use management table associated with the target DLL to stop subsequent issue of the right to access the target DLL (step 504).

If the ID of a new thread 102 is registered as a using thread ID in the DLL use management table associated with the target DLL (step 506), the DLL use control section 1031 instructs the newly registered thread 102 to stop using the target DLL (step 518).

When all of the rights to access the target DLL are returned and the number of DLL access right holding threads in the DLL use management table associated with the target DLL is “0” (step 508), the DLL use control section 1031 issues an update ready notification that the update of the target DLL is ready to the DLL management section 1032 (step 510).

When receiving an update completion notification that the update of the target DLL is completed from the DLL management section 1032 (step 512), the DLL use control section 1031 enters “NORMAL” as the DLL status in the DLL use management table associated with the target DLL to resume issuing the right to access the target DLL (step 514). In addition, the DLL use control section 1031 notifies each thread 102 whose ID has been entered as the using thread ID in the DLL use management table associated with the target DLL of resuming the use of the target DLL (step 516) and then terminates the process.

At this time, each thread 102, which has been notified of resuming the use of the target DLL, resumes the usual use of the target DLL.

An operation of updating the target DLL accompanying the above-described DLL updating process and DLL use limiting process will be described in time series below.

First, the DLL management section 1032 sets the DLL 101, which is one of the DLLs 101 loaded at this time and is older than the latest-version DLL 101 downloaded in the HDD 16, as a target DLL and notifies the DLL use control section 1031 of starting update of the target DLL (step 402).

In response to this notification, the DLL use control section 1031 instructs each thread 102 using the target DLL to stop using the target DLL (step 502) and also stops issuing a right to access the target DLL (step 504).

On the other hand, each thread 102, which has been instructed to stop using the target DLL, stops subsequent issue of an access right request relevant to the target DLL. If the thread 102 holds the right to access the target DLL at this time, the thread 102 terminates the use of a function of the target DLL and returns the right to access the target DLL.

After that, if the ID of a new thread 102 is entered as a using thread ID in the DLL use management table associated with the target DLL (step 506), the DLL use control section 1031 instructs the newly registered thread 102 to stop using the target DLL (step 518).

When all of the rights to access the target DLL are retuned and the number of DLL access right holding threads in the DLL use management table associated with the target DLL is “0” (step 508), the DLL use control section 1031 issues an update ready notification that the update of the target DLL is ready to the DLL management section 1032 (step 510).

On the other hand, when receiving the update ready notification (step 404), the DLL management section 1032 allows the DLL loading/update processing section 1033 to update the target DLL to the latest-version DLL 101 downloaded in the HDD 16 (step 406). At the completion of updating, the DLL management section 1032 issues an update completion notification that the update of the target DLL is completed to the DLL use control section 1031 (step 408).

When receiving the update completion notification (step 512), the DLL use control section 1031 resumes issuing the right to access the target DLL (step 514) and notifies each of the threads 102 using the target DLL of resuming the use of the target DLL (step 516).

In response to this notification, each thread 102 resumes the usual use of the target DLL.

The embodiment of the present invention has been described.

According to the embodiment, as described above, a loaded DLL 101, serving as a target to be updated, is updated after only the access to the target DLL from each thread 102 using the DLL 101 is stopped. Accordingly, the target DLL 101 can be updated without stopping the entire in-vehicle system 1 or each thread 102 which does not use the target DLL 101. In addition, after the access to the target DLL is resumed, each thread 102 using the target DLL uses the updated DLL 101. This prevents that a plurality of versions of the DLL 101 exist and are used.

The above embodiment has been described with respect to the case where the latest-version DLL 101 is acquired from the DLL distribution server 2. The latest-version DLL 101 may be acquired from a removable medium, such as a DVD, loaded in the removable medium drive 17.

In the above-described embodiment, when an access error related to a loaded DLL 101 occurs, the latest-version DLL 101 is downloaded or the loaded DLL 101 is updated to the latest version. The latest-version DLL 101 may be acquired at any moment other than the above-described time. For example, upon loading a DLL 101, whether the version of the loaded DLL 101 is the latest is determined. If it is not the latest version, the latest-version DLL 101 may be downloaded, alternatively, the loaded DLL 101 may be updated to the latest version.

As for a thread 102 which creates a link to a DLL 101 in the application upon loading the DLL 101, when the thread is notified of resuming the use of a target DLL, the thread 102 may again create a link to the target DLL.

Although preferred embodiments have been described in detail, the present invention is not limited to these specific embodiments of the present invention. Rather, various modifications and changes can be made without departing from the scope of the present invention as described in the accompanying claims. Accordingly, all such modifications are intended to be included within the scope of this invention as defined in the following claims.

What is claimed is:

1. A shared-program updating system for updating a shared program that is loaded in a memory and is dynamically linked to and shared by other programs, the system comprising:
an update processing unit that updates a target shared program, which is shared by the other programs, and which is to be updated, wherein
the update processing unit includes:
an updating access control section that directs each of a plurality of using programs, serving as the other programs that access the target shared program, to stop accessing the target shared program and, after the target shared program is updated, allows the using program to resume accessing the target shared program; and
an updating section that updates the target shared program after the using program has stopped accessing the target shared program.

2. The system according to claim 1, further comprising:
a use control unit that issues a right to access the shared program (access right) to each of the other programs in response to a request from the other program, and receives back the access right returned from the other program, wherein
the updating access control section directs the use control unit to stop issuing the access right and, after the target shared program is updated, allows the use control unit to resume issuing the access right;
after the updating access control section directs the use control unit to stop issuing the access right, and all of the access rights are returned back from the using programs, the updating section updates the target shared program; and
the other program using the shared program requests the use control unit to issue the access right, and thereafter, the other program accesses the shared program, and upon completion of the access, returns the access right back to the use control unit.

3. The system according to claim 2, wherein the shared program is a dynamic link library (DLL).

4. The system according to claim 2, further comprising:
an update control unit configured to:
search for a newer version of the shared program when the access of the shared program by at least one of the using programs fails due to a program on a shared program side;
acquire a latest version of the shared program when the newer version is found;
set the shared program corresponding to the found newer version as the target shared program; and
allow the update processing unit to update the target shared program.

5. The system according to claim 4, wherein the update control unit accesses a distribution server containing the shared program, searches for the newer version of the shared program, and acquires a latest version of the shared program from the distribution server.

6. The system according to claim 4, wherein the update control unit accesses a removable medium containing the shared program, searches for the newer version of the shared program, and acquires the latest version of the shared program from the removable medium.

7. The system according to claim 1, further comprising:
a use control unit that issues a right to access the shared program (access right) to each of the other programs in response to a request from the other program, and receives back the access right returned from the other program, wherein
the updating access control section directs the use control unit to stop issuing the access right, and notifies each using program of stopping of the access right, and after the target shared program is updated, allows the use control unit to resume issuing the access right, and notifies the using program of resuming the use of the target shared program;
after the updating access control section directs the use control unit to stop issuing the access right, and all of the access rights are then returned back from the using programs, the updating section updates the target shared program;
the other program using the shared program, requests the use control unit to issue the access right, and thereafter, the other program accesses the shared program, and upon completion of the access, returns the access right back to the use control unit; and
each of the using programs stops accessing the target shared program and suspends requesting the access right during the interval between when the using program is notified of stopping the use of the target shared program and the time when the using program is notified of resuming the use.

8. The system according to claim 7, wherein the shared program is a DLL.

9. The system according to claim 7, further comprising:
an update control unit configured to:
search for a newer version of the shared program when access to the shared program by at least one of the using programs fails due to a program on a shared program side;
acquire a latest version of the shared program when the newer version is found;
set the shared program corresponding to the found newer version as the target shared program; and
allow the update processing unit to update the target shared program.

10. The system according to claim 9, wherein the update control unit accesses a distribution server containing the shared program, searches for the newer version of the shared program, and acquires a latest version of the shared program from the distribution server.

11. The system according to claim 9, wherein the update control unit accesses a removable medium containing the shared program, searches for the newer version of the shared program, and acquires the latest version of the shared program from the removable medium.

12. The system according to claim 1, further comprising:
an update control unit configured to:
search for a newer version of the shared program when access of the shared program by at least one of the using programs fails due to a problem on a shared program side;
acquires latest version of the shared program when the newer version is found;
set the shared program corresponding to the found newer version as the target shared program; and
allows the update processing unit to update the target shared program.

13. The system according to claim 12, wherein the update control unit accesses a distribution server containing the shared program, searches for the newer version of the shared program, and acquires the latest version of the shared program from the distribution server.

14. The system according to claim 12, wherein the update control unit accesses a removable medium containing the shared program, searches for the newer version of the shared program, and acquires the latest version of the shared program from the removable medium.

15. The system according to claim 1, wherein the shared program is a DLL.

16. The system according to claim 1, wherein the system is an in-vehicle system mounted on a car.

17. A computer program that is read and executed by a computer, wherein
the computer program allows the computer to function as a shared-program updating system for updating a shared program that is dynamically linked to and shared by other programs;
the system includes an update processing unit that updates a target shared program, which is shared by the other programs and which is to be updated; and
the update processing unit includes:
an updating access control section that directs each of a plurality of using programs, serving as the other programs that access the target shared program, to stop accessing the target shared program and, after the target shared program is updated, allows the using program to resume accessing the target shared program; and
an updating section that updates the target shared program after the using program has stopped accessing the target shared program.

18. The computer program according to claim 17, wherein
the system further includes a use control unit that issues a right to access the shared program (access right) to each of the other programs in response to a request from the other program, and receives back the access right returned from the other program;
the updating access control section directs the use control unit to stop issuing the access right and, after the target shared program is updated, allows the use control unit to resume issuing the access right;
after the updating access control section directs the use control unit to stop issuing the access right, and all of the access rights are then returned back from the using programs, the updating section updates the target shared program; and
the other program using the shared program requests the use control unit to issue the access right, and thereafter, the other program accesses the shared program, and upon completion of the access, returns the access right back to the use control unit.

19. The computer program according to claim 17, wherein
the system includes a use control unit that issues a right to access the shared program (access right) to each of the other programs response to a request from the other program, and receives back the access right returned from the other program;
the updating access control section directs the use control unit to stop issuing the access right and notifies each using program of stopping of the access right, and after the target shared program is updated, allows the use control unit to resume issuing the access right, and notifies the using program of resuming the use of the target shared program;
after the updating access control section directs the use control unit to stop issuing the access right, and all of the access rights are then returned back from the using programs, the updating section updates the target shared program,
the other program using the shared program, requests the use control unit to issue the access right, and thereafter, the other program accesses the shared program, and upon completion of the access, returns the access right back to the use control unit, and
each of the using programs stops accessing the target shared program and suspends requesting the access right during the interval between when the using program is notified of stopping the use of the target shared program and the time when the using program is notified of resuming the use.

20. The computer program according to claim 17, wherein the shared program is a DLL.
